(19) United States
(12) Patent Application Publication
(10) Pub. No.: US 2013/0139444 A1
(43) Pub. Date: Jun. 6, 2013

(54) RELATION TO DOUBLE HUNG WINDOWS

(71) Applicant: Robert Charles Langner, (US)

(72) Inventor: Robert Charles Langner, (US)

(73) Assignee: ANEETA WINDOW SYSTEMS (VIC) PTY LTD, Mitcham (AU)

(21) Appl. No.: 13/311,663

(22) Filed: Dec. 6, 2011

(51) Int. Cl. E06B 3/44; E06B 7/16; E05D 15/16

(52) U.S. Cl. 49/440

(57) ABSTRACT

A sashless window includes upper, lower and side frame members to define a generally square or rectangular frame. First and second panes are positioned within the frame and are mounted for substantially vertical and parallel movement within the frame. Each of the side frame members defines a channel into which opposite side edges of the panes extend. The channel includes elongate guide members for guiding vertical movement of the panes whereby the first and second guide members extend to positions facing front and rear faces, respectively, of the first and second panes, respectively. Each of the guide members includes a seal extending into contact with the face of the respective pane. A third guide member extends to a position between the panes and includes a pair of seals projecting in opposite directions and extending into contact with facing surfaces of the first and second panes.

### FIELD OF THE INVENTION

The invention relates to double hung windows, which generally consist of a window pane which is suspended in a frame and which is moveable vertically relative to the frame. The pane can be connected either to another pane or to a counterbalancing weight by a suitable pulley or cord arrangement, so that upward or downward movement of the pane causes a corresponding downward or upward movement of the other pane or the counterbalancing weight.

### BACKGROUND OF THE INVENTION

Applicant has developed double hung windows in the past and has secured grant of Australian Patent Nos. 681964 and 755903, each which provide for improved window arrangements.

Because of the nature of double hung windows, in particular, the nature of how those windows slide vertically, they are difficult to seal against draughts and ingress of rain. Moreover, the construction of double hung windows can be complex so improvements in manufacture and installation can have a significant effect on handling, transport and storage which all contribute to savings in cost, while the same improvements can reduce carbon footprint which is becoming a major factor in window construction. Thus, applicant recognises that further improvements in window construction would be desirable.

### SUMMARY OF THE INVENTION

According to the present invention there is provided a sashless window comprising:

upper, lower and side frame members,

first and second panes positioned within the frame substantially parallel to each other and at least the first pane being mounted for substantially vertical and parallel movement within the frame relative to the second pane,

each of the side frame members defining a channel into which opposite side edges of each of the first and second panes extend,

the channel including elongate guide members for guiding vertical movement of the at least first pane,

the channels of each of the side frame members including:

a first guide member extending to a position facing a front face of the first pane and a seal extending from the first guide member and into contact with the front face of the first pane,

a second guide member extending to a position facing a rear face of the second pane and a seal extending from the second guide member and into contact with the rear face of the second pane,

a third guide member extending to a position between the first and second panes and including a pair of seals projecting in opposite directions and extending into contact with facing surfaces of the first and second panes.

A sashless window according to the invention can simplify the construction and installation of a window compared to prior art arrangements by reducing or eliminating the requirement to prepare the glass panes by applying seals or pane receiving members to the edges of the panes. In prior art arrangements, the possibility that the glass of a pane could come into contact with an aluminium guide member required the provision of pane receiving members or other suitable treatment usually to the glass. Contact between glass and aluminium must be avoided as it creates wear and noise. The provision of seals that project from the third guide member into contact with facing surfaces of the first and second panes can prevent contact between the panes and the third guide member and thus remove the need for the application of pane receiving members.

The removal of the need for the application of pane receiving members or other pane treatment can provide significant advantages over the prior art. For example, because the pane construction and/or installation can be simplified, the invention provides the potential to eliminate an entire step in the window construction, even potentially allowing glass panes to be shipped directly to an installation site without any previous factory treatment. This can have a major impact on the requirements for handling, transport and storage of glass panes for windows, especially for remote sites and large glass sizes. It can also have a major impact on the carbon footprint of a window, which is an increasingly significant factor in window construction.

A sashless window according to the invention can also improve the rating of a window according to the prior art, in terms of weather rating, and also potentially in respect of sound rating. That is, the window will seal against the ingress of air and water more effectively than prior art windows, so that the weather rating and the energy performance of the window will improve, while the window will also insulate against ingress of external sound, again, better than prior art windows. The seals of the third guide member can also assist to reduce window rattle.

In some forms of the invention, pane receiving members are fixed to the opposite side edges of each of the first and second panes. In those forms of the invention, the pane receiving members are disposed at least substantially within the channels of the side frame members and the facing surfaces of the first and second panes that the seals of the third guide member contact are facing surfaces of the pane receiving members. In these forms of the invention there is thus provided a sashless window comprising:

upper, lower and side frame members defining a square or rectangular frame,

first and second panes positioned within the frame substantially parallel to each other and at least the first pane being mounted for substantially vertical and parallel movement within the frame relative to the second pane,

each of the side frame members defining a channel into which opposite side edges of each of the first and second panes extend,

pane receiving members being fixed to the opposite side edges of each of the first and second panes and being disposed at least substantially within the channels of the side frame members,

the channel including elongate guide members for guiding vertical movement of the at least first pane,

the channels of each of the side frame members including:

a first guide member extending to a position facing a front face of a first pane receiving member attached to the side edge of the first pane and a seal extending from the first guide member and into contact with the first pane receiving member,

a second guide member extending to a position facing a rear face of a second pane receiving member attached to the side edge of the second pane and a seal extending from the second guide member and into contact with the second pane receiving member, a third guide member extending to a position between the first and second pane receiving members and including a pair of seals projecting in opposite directions and extending into contact with facing surfaces of the first and second pane receiving members.

The seals that project from the third guide member can project at any suitable position relative to the guide member. In some forms of the invention, the seals of the third guide member project from the same position on the guide member, so that the seals are mounted back-to-back on the third guide member. The seal could alternatively be a single double sided seal.

In other forms of the invention, the position in which the seals of the third guide member project from that member is different. In some forms, the third guide member has a lengthwise extent and the seals of the third guide member are spaced apart in the lengthwise direction. That is, one seal is positioned closer to the distal end of the third guide member, while the other seal which projects in the opposite direction is positioned inboard of that seal.

In some forms of the invention, the channel of the side frame members is defined by a base and opposite side walls which extend from the base. In those forms of the invention, the third guide member can extend from the base of the channel into the position between the first and second panes or the first and second pane receiving members. The third guide member can extend at an angle perpendicular to the base, or at a different angle to the base.

The respective seals of the third guide member can be immediately adjacent one another, or can be a single double sided seal, or the seals can be spaced apart. Moreover, the seals can be identical in construction, or they can be differently constructed. For example, some forms of seals which are suitable for application to the third guide member include a base portion which is fixed to the third guide member by location within a groove formed in the third guide member. The groove can include a narrow opening through which a sealing portion of the seal can extend and the narrow opening can prevent release of the base portion from out of the groove. In this arrangement, the seals can be applied to the third guide member by sliding the base portion into the groove from one end of the third guide member.

The seals of the third guide member can include a fin which extends from the base portion for contact with a facing surface of a respective one of the first and second panes or the first and second pane receiving members. The seals can also include a pile arrangement which extends from the base portion and like the fin, the pile arrangement can extend into contact with a facing surface of a respective one of the first and second panes or the first and second pane receiving members.

While the seals of the third guide member can extend into contact with facing surfaces of the first and second panes or the first and second pane receiving members in any suitable form, in some forms of the invention, the facing surfaces include a recess in which contact by the seals is made. This can improve sealing and aid tracking of the panes vertically.

The upper, lower and side frame members can define a generally square or rectangular frame or a frame of different shape, For example, the upper frame member can be raked (angled) or curved (arched).

In some forms of the invention, the side frame members are formed of two or more parts that are connectable together and the third guide member can be formed as one of the parts. In other forms of the invention, the side frame members can be formed of three or more parts which are connectable together and those parts can include further guide members and further panes.

The present invention can be applied to a variety of different forms of sashless windows. In some forms, the first and second panes are each moveable vertically relative to each other. In other forms, one of the first and second panes is fixed within the window frame, and the other is moveable vertically. In each of these forms, movement of the panes is between a closed position and an open position. In the closed position, there is normally a small overlap between respective bottom and top edges of the respective first and second panes, and in the open position, there is almost complete overlap between the panes.

In other forms of sashless windows according to the invention, three or four panes are provided. In three pane arrangements, one of the panes can be fixed with the other two panes being moveable, or two of the panes can be fixed with only one of the panes being moveable. Reference later herein will be made to figures which illustrate these various arrangements.

As indicated above, four pane arrangements are within the scope of the present invention and it will be appreciated that even further panes can be added as required. However, in typical arrangements in which applicant is involved, the maximum pane number is usually four.

Where three or four panes are provided, further guide members can be provided to extend to a position between adjacent panes.

The pane receiving members, if provided can be formed of any suitable material. In some forms, the pane receiving members are formed from plastic while in other forms they are formed of metal, such as aluminium. In some forms of the invention the pane receiving members and the third guide member can each be formed of aluminium. This is because the seals of the third guide member can be arranged to prevent contact between the pane receiving members and the third guide member, so that there is no metal to metal contact. Aluminium pane receiving members and third guide members can provide advantages in the production of high performance fire rated windows. Moreover, adhesives to adhere aluminium to glass can be easier to use (at least at present) than adhesives for adhering plastic to glass.

### BRIEF DESCRIPTION OF THE DRAWINGS

In order that the invention may be more fully understood, some embodiments will now be described with reference to the figures in which:

FIGS. 1a to 1f illustrates front views of various sashless window arrangements to which the present invention can be applied.

FIG. 2 is a side cross sectional view through A-A of FIG. 1a.

FIG. 3 is a cross sectional view taken through B-B of FIG. 1a.

FIG. 4 is a similar cross sectional view to FIG. 3 illustrating an arrangement according to the invention which employs double glazed panes.

FIG. 5 is a similar cross sectional view to FIG. 3 illustrating an arrangement according to the invention which employs low flammability index seals.

FIG. 6 is a similar cross sectional view to FIG. 3 illustrating an alternative seal arrangement.

FIG. 7 is a similar cross sectional view to FIG. 3 illustrating an arrangement according to the invention which employs panes without pane receiving members.

### DETAILED DESCRIPTION OF THE DRAWINGS

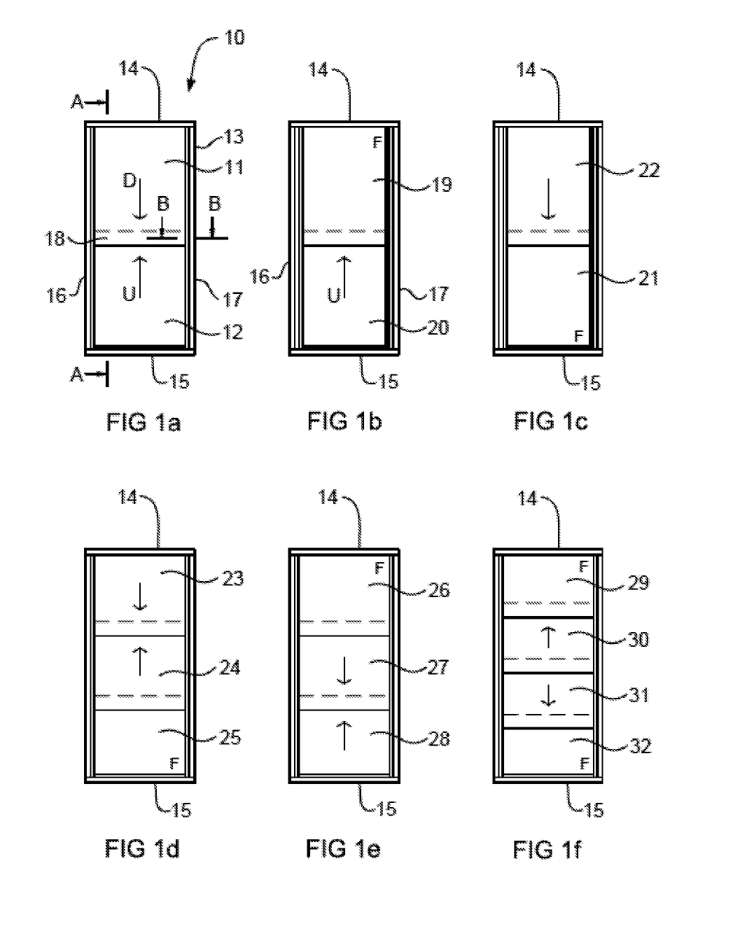

Different types of sashless and double hung windows are illustrated in FIGS. 1a to 1f. In FIG. 1a, a two-pane double hung window is illustrated in a closed position. The window 10 includes first and second panes 11 and 12 which are mounted within a rectangular frame 13 comprising upper and lower frame members 14 and 15 and side frame members 16 and 17. The window 10 includes an overlap 18 when the panes 11 and 12 are in the position shown in FIG. 1a, and the movement of panes is shown by the arrows D (down) and U (up) when the panes are shifted from the closed position in FIG. 1a, to an open position. By that movement, each pane moves about 50% of its height, so that there is substantial overlap between the panes 11 and 12 and so that gaps in the window frame 13 open at the top and bottom of the frame, adjacent the upper and lower members 14 and 15.

FIGS. 1b to 1f illustrate alternative arrangements, but each includes substantially the same frame members as illustrated in FIG. 1a, with the distinction that the frames of FIGS. 1b and 1c have extra side members to accept counterbalancing weights. Nevertheless, the same references will be used for the frame members of all of FIGS. 1a to 1f.

In FIG. 1b, a pane 19 is fixed in place relative to the frame members 14 to 17, while the pane 20 is moveable relative to the frame members and to the pane 19. As shown by the arrow U. In FIG. 1b, the pane 20 can move vertically upwardly from the closed position of the window shown in FIG. 1b, to create a gap adjacent the frame member 15. Movement of the pane 20 can be to a position in which there is substantial overlap with the pane 19, so that a gap which is approximately equal to the size of the pane 20 is created.

FIG. 1c illustrates a reverse arrangement to that in FIG. 1b, in which the bottom pane 21 is fixed and the upper pane 22 is moveable vertically relative to both the frame members and the pane 21.

FIG. 1d illustrates a three-pane arrangement, in which panes 23 and 24 are moveable, but pane 25 is fixed. In respect of panes 23 and 24, they move in a manner which is essentially the same as the panes 11 and 12 of FIG. 1a, so that movement of the panes 23 and 24 in the direction shown by the arrows causes gaps to open in the window adjacent the upper frame member 14 and above pane 25.

In FIG. 1e, a further three-pane arrangement is illustrated, in which upper pane 26 is fixed, and middle pane 27 and lower pane 28 are moveable. By this arrangement, a gap is created beneath the fixed pane 26 and adjacent the bottom frame member 15 when the panes 27 and 28 are shifted from the closed position shown in FIG. 1e to an open position.

Finally, FIG. 1f illustrates a four-pane arrangement, in which panes 29 and 32 are fixed and panes 30 and 31 are moveable. In this arrangement, a central opening is created by movement of the pane 30 in an upward vertical direction and pane 31 in a downward vertical direction.

Other window configurations exist and include fixed top and bottom panes with a movable centre pane. The centre pane can move up or down. It will be appreciated that other configurations could be created and those illustrated and described above are just examples. The invention could apply to many different configurations.

In each of the illustrations of FIGS. 1a to 1f, in the closed position, there is overlap between adjacent panes. Moreover, in most cases, when the panes have been moved as described, a greater overlap occurs to create an opening in the window.

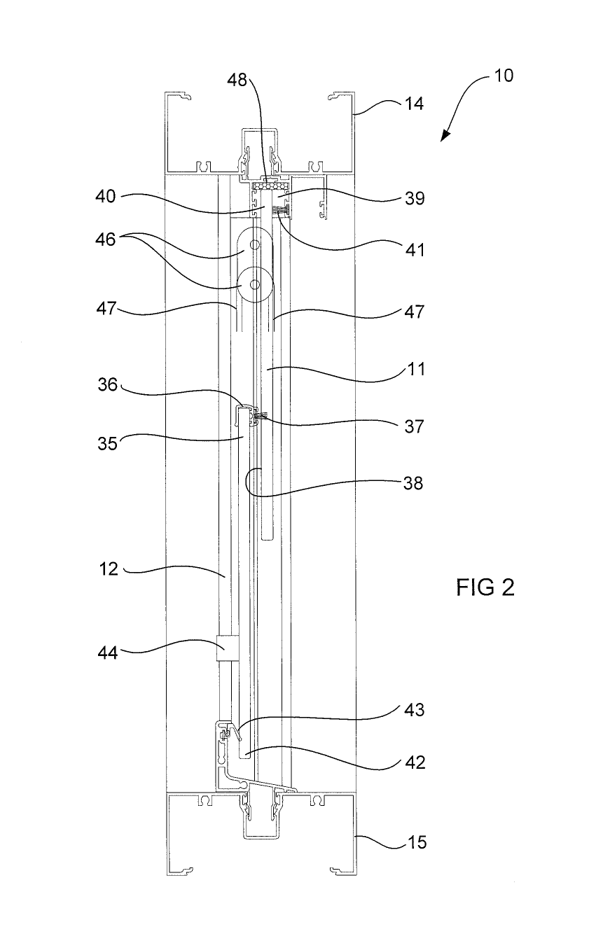

FIG. 2 is a side cross sectional view of the two-pane arrangement illustrated in FIG. 1a. In FIG. 2, the upper and lower frame members 14 and 15 are illustrated, as are panes 11 and 12. FIG. 2 clearly illustrates that the panes 11 and 12 are mounted within the window frame parallel to one another so that they can accommodate relative vertical movement.

In FIG. 2, a pulley arrangement is partially illustrated which provides for cords to be connected to the panes 11 and 12, so that the raising of one of the panes 11 and 12 results in the lowering of the other pane 11 and 12. For example, if the panes 11 and 12 are in the closed position shown in FIGS. 1a and 2, upward movement of the pane 12 results, through the pulley arrangement, in downward movement of the pane 11. The reverse movement occurs when the pane 11 is moved upwardly back to the position shown in FIG. 1a.

It is evident from FIG. 2 that upward and downward movement of the respective panes 11 and 12 is through a vertical plane. In addition, the movement is such that the panes 11 and 12 remain generally parallel to each other as movement occurs.

For weather protection, the upper end 35 of the pane 12 includes a pane receiving member 36 from which extends a seal 37 for contact with the facing surface 38 of the pane 11. In the figure, the seal 37 is shown extending to its full extent, but it will be appreciated that the end of the seal 37 extends into contact with the surface 38 and does not project further than that surface

The arrangement illustrated in FIG. 2 includes a recess 39 into which the upper end 40 of the pane 11 extends when the panes 11 and 12 are in the closed position of FIG. 1a. Movement of the pane 11 downwardly releases the end 40 from the recess 39. The extension of the end 40 into the recess 39 provides for weather protection, by minimising the likelihood of wind and rain from travelling past the upper edge of the pane 11. A seal 41 and a foam seal 48 enhances the weather proofing of the upper end of the pane 11.

At the bottom end 42 of the pane 12, a further sealing arrangement 43 is provided to prevent ingress of wind and rain etc. past the bottom end 42 of the pane 12.

A handle 44 can be applied to either of the panes, but as shown, is applied to the pane 12 in FIG. 2. The handle 44 can be used to raise or lower the pane 12, which in the FIG. 2, is the inside pane, relative to a building to which the window 10 is applied.

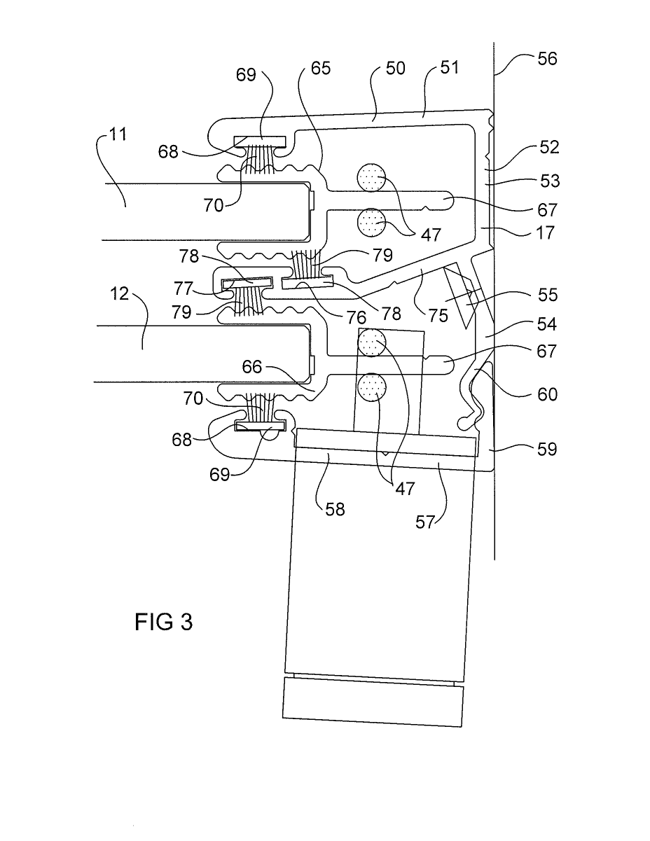

The pulley arrangement illustrated in FIG. 2 includes pulley 46 and a cord 47 extending from the pulley into engagement with the respective panes 11 and 12. Full illustration of the arrangement of pulleys and cords is not made as they are not features of particular relevance to the present invention. However, the cord 47 is also illustrated in FIG. 3 and reference to that figure will now be made.

In FIG. 3, one of the two side sections of panes 11 and 12 is illustrated. Each of the side sections extends into the side frame members 16 and 17 in FIG. 1a. FIG. 3 illustrates the side frame member 17 in cross-section.

The side frame member 17 is an extruded aluminium section formed of two interconnecting parts although other materials and methods of formation can be adopted. The first part 50 includes a side portion 51 and a base portion 52. The base portion 52 comprises a first planar portion 53 and a second interlocking portion 54. A screw head 55 of a screw is shown, which is used to fix the first part 50 to the frame 56 surrounding the window 10. The frame 56 could typically be either timber or aluminium.

The second part 57 of the side frame member 17 includes a side portion 58 and a base portion 59. As is evident from FIG. 3, the base portion 59 interlocks with the section 60 of the interlocking portion 54 of the first part 50. In practice, the first part 50 can be installed with the screw 55 inserted to fix it in place relative to the frame 56, where after the second part 57 can be snapped into interlocking engagement with the first part 50.

The side edges of the panes 11 and 12 each include pane receiving members 65 and 66, although it is to be appreciated that the invention covers an arrangement in which the pane receiving members 65 and 66 are not provided. Each pane receiving member 65 and 66 defines a recess to receive the edge of the respective panes 11 and 12, and a leg 67 which extends towards the respective base portions 52 and 59 of the first and second parts 50 and 57. Cord 47 is attached to the leg 67 of each pane receiving member 65 and 66 for raising and lowering the panes 11 and 12 about the pulley 46 within the window 10. The leg 67 can also be used to for locking the panes shut or open by forming an opening in the leg and extending a lockable plunger therethrough. The spacing between the distal end of the leg 67 and the respective facing surfaces of the first planar portion 53 or the second interlocking portion 54 can be modified as necessary to adjust the clearance between them.

Each of the side portions 51 and 58 includes a recess 68 to accommodate the base 69 of a pile seal 70. The pile seal 70 extends into contact with the facing surface of the respective pane receiving members 65 and 66 to form a seal between the side portions 51 and 58 and the pane receiving members 65 and 66 (or the facing surfaces of the panes if the pane receiving members 65 and 66 are not provided).

The side portions 51 and 58 also form first and second guide members for guiding vertical movement of the panes 11 and 12. Thus, by the interaction of the seals 70 with the side portions 51 and 58 and the facing surfaces of the pane receiving members 65 and 66, movement of the panes 11 and 12 can be guided substantially vertically and rattling movement of those panes 11 and 12 within the window 10 can be reduced or minimised.

A third guide member 75 extends from the base portion 52 of the first part 50 to a position between the first and second pane receiving members 65 and 66 (or to a position between the facing surfaces of the panes if the pane receiving members 65 and 66 are not provided). The member 75 includes a pair of recesses 76 and 77 to accept the bases 78 of further pile seals 79. The seals 79 extend from the recesses 76 and 77 in opposite directions and contacts facing surfaces of the first and second pane receiving members 65 and 66 (or the facing surfaces of the panes if the pane receiving members 65 and 66 are not provided). The facing surfaces of those members can be recessed so that the seals 79 extend into the recessed portions of the first and second pane receiving members 65 and 66.

As illustrated in FIG. 3, the seals 79 are positioned at the distal end of the guide member 75 and are spaced apart longitudinally of the member 75, i.e. in a direction between the base portion 52 of the first part 50 and the distal end of the member 75.

The use of the seals 79 as illustrated in FIG. 3 provides further sealing improvement for the window 10. Thus, weather ingress, in the form of wind, dust and rain, is prevented or at least restricted by virtue of the seals 70 between the first parts 50 and 58 of the side frame members 16 and 17, and by the seals 79 which extend in opposite directions from the third guide member 75. Thus, sealing against ingress of wind, dust or rain through the window 10 is enhanced by the use of the oppositely facing seals 79 while sound-proofing of the window can also be enhanced.

It will be appreciated from earlier discussions, that the seals 79 could be positioned back-to-back, rather than in the lengthwise spaced relationship shown in FIG. 3. However, the arrangement in FIG. 3 is advantageous in minimising the space required between the panes 11 and 12.

The seal arrangement of the window 10 does not require modification of some current forms of windows, so that the seals as illustrated in FIG. 3 can be installed without the current window dimensions being altered. All that is required is to re-configure the third guide member 75 to accept the seals 79.

The seals discussed above have been described as including a base which is captured in a respective recess, and piles that extend from the base. The seals could alternatively be formed to include a fin which also extends from the base in addition to the pile, or the pile could be eliminated and only the fin provided. The invention contemplates a mixture of different types of seals, such as of the kinds discussed above or different kinds as might be suitable, as required for weather, sound or fire proofing.

While the window 10 has been developed for simplified construction and installation of the window and improved weather-proofing against ingress of wind and/or rain from outside the window, windows according to the invention can also have improved insulation against air leakage from inside the building, i.e. to resist leakage of heated or cooled air out of a building and thus to improve energy efficiency of the building into which the window is installed. As indicated earlier, the improvements in energy efficiency, construction and installation of a window according to the invention advantageously reduces the overall carbon footprint of the window.

The seals that extend from the guide member 75 prevent contact between the pane receiving members 65 and 66 and the guide member 75 (or will prevent contact between the facing surfaces of the panes and the guide member 75 if the pane receiving members 65 and 66 are not provided), which is important for proper operation of a window assembly in terms of noise minimisation and smooth operation.

The benefits as described above will apply to the window 10 shown in the drawings, as well as other forms of the invention which are not illustrated or which are discussed below.

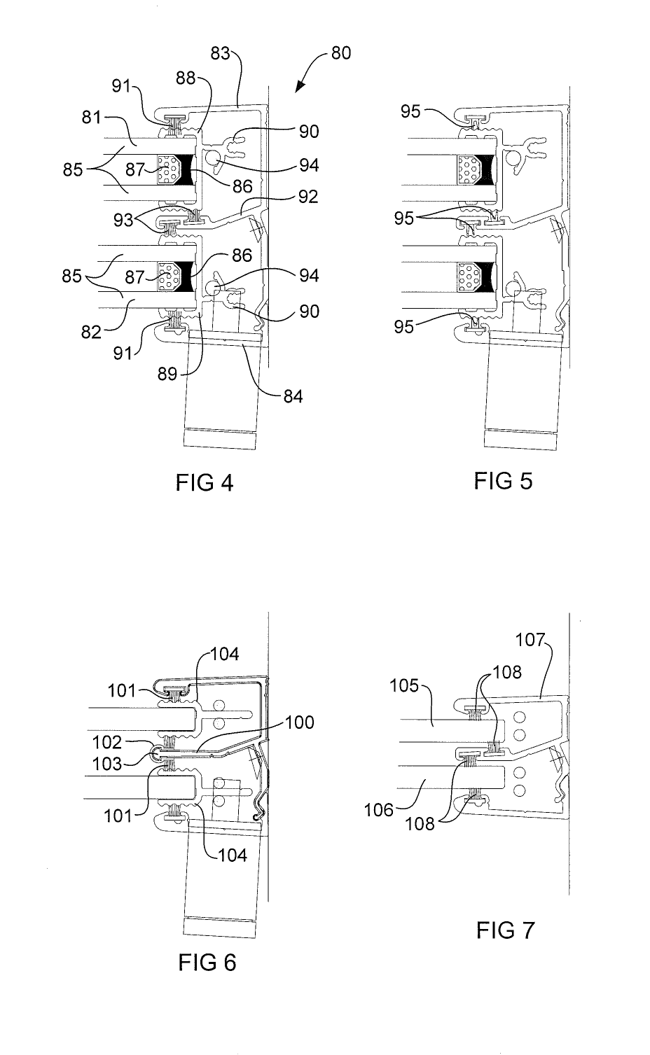

FIG. 4 illustrates in cross-sectional view, a further form of the invention which is in many respects the same as the form illustrated in FIG. 3, but the panes in FIG. 4 are double glazed panes rather than the single panes of FIG. 3. Thus, in FIG. 4, a cross-sectional view of a frame member 80 is illustrated including double glazed panes 81 and 82.

The frame member 80 is constructed in the same manner as the frame member 17 of FIG. 3. Thus the frame member 80 is formed of two interconnecting parts 83 and 84 that interconnect in the same manner as the first and second parts 50 and 57 of the frame member 17 and which is evident from the illustration of FIG. 4. Thus, further discussion of the construction of the frame member 80 will not be made.

The panes 81 and 82 include spaced apart pane lites 85 that are formed according to known double glazing techniques to include a seal 86 and a spacer 87. The side edges of the panes 81 and 82 each include pane receiving members 88 and 89, although as with the arrangement of FIG. 3, it is to be appreciated that the invention covers an arrangement in which the pane receiving members 88 and 89 are not provided. Each pane receiving member 88 and 89 defines a recess to receive the edge of the respective panes 81 and 82, and each member 88 and 89 includes a leg 90 which extends towards the respective base portions of the parts 83 and 84. The configuration of the leg 90 allows for a pile seal (not shown) to be attached to the leg to prevent contact between the pane receiving members 88 and 89 and the frame member 80. A cord 94 is attached to the leg 90 of each pane receiving member 88 and 89 for raising and lowering the panes 81 and 82. The leg 90 can also be used to for locking the panes 81 and 82 in the manner described in relation to FIG. 3.

In other respects the arrangement of FIG. 4 is the same as FIG. 3, in that pile seals 91 extend from the parts 83 and 84 into contact with the facing surface of the respective pane receiving members 88 and 89 to form a seal therebetween (bearing in mind that the seal could be formed between the parts 83 and 84 and facing surfaces of the panes 81 and 82 if the pane receiving members 88 and 89 are not provided).

The frame member 80 further includes a guide member 92 that extends to a position between the first and second pane receiving members 88 and 89 (or to a position between the facing surfaces of the panes 81 and 82 if the pane receiving members 88 and 89 are not provided). The member 92 includes a pair of further seals 93 located in recesses in the guide member 92 and extending in opposite directions to engage facing surfaces of the first and second pane receiving members 88 and 89 (or the facing surfaces of the panes 85 if the pane receiving members 90 are not provided).

FIG. 5 is essentially the same arrangement as FIG. 4 except that the seals 95 of FIG. 5 have a low flammability index. Accordingly, the same reference numerals have been employed in FIG. 5 for the same parts that appear in FIG. 4.

FIG. 6 illustrates an alternative arrangement that has a similar construction to the FIG. 3 arrangement so that like parts have been given the same reference numerals. The difference between the FIGS. 3 and 6 arrangements is in the construction of the guide member 100 and the attachment of the seals 101 to the guide member 100.

As can be seen in FIG. 6, the guide member 100 does not include recesses of the kind included in the guide member 75 of the FIG. 3 arrangement. In contrast, the guide member 100 includes no recesses because the seals 101 are formed as part of a clip arrangement which comprises the seals extending from a clip 102 that fixes to the distal end of the guide member 100. For this, the distal end of the guide member 100 includes an enlarged head 103 and the clip is formed complementary to the distal end of the guide member 100. The clip is secured to the enlarged head 103 and the seals 101 extend from the clip 102 into engagement with the facing surface of the pane receiving members 104. This arrangement provides advantages in simplifying the construction of the guide member 100.

FIG. 7 illustrates an arrangement similar to the arrangement of FIG. 3, except that in the FIG. 7 arrangement, the panes 105 and 106 do not include pane receiving members of the kind numbered 65 and 66 in FIG. 3.

In FIG. 7, the frame 107 has the same construction as the frame 17 of FIG. 3, however the pile seals 108 each extend into contact with facing surfaces of the respective panes 105 and 106.

The FIG. 7 arrangement offers significant advantages by the elimination of the pane receiving members. Because the glass which is used in the window assembly does not have pane receiving members attached to it, this eliminates a production step that is currently undertaken in window assemblies that include panes with pane receiving members attached in the manner of the earlier figures. Quite clearly, the consequence of this is a cost saving in manufacture by the elimination of the cost of the actual pane receiving members that are at present applied to the glass panes along with the adhesive that is used to fix the pane receiving members in place. In addition, there is a cost saving in the manual labour that is undertaken to apply the pane receiving members to the glass panes.

The above cost savings are direct savings that occur immediately the invention is employed without pane receiving members being applied. However, the cost savings go beyond this, in that the invention enables glass panes to be shipped directly to the site of installation of the window assembly from the pane manufacturer or pane supplier without first going to a factory assembly site for application of the pane receiving members as is currently done. This removes double handling of the panes and enables panes to be shipped direct from pane manufacturers or suppliers, for example from pane manufacturers or suppliers in closest proximity to the installation site of the window assembly. At present, the pane manufacturers or suppliers are sometimes selected on the basis of proximity to the factory in which the pane receiving members are applied to the panes and then the panes are shipped to the site of installation. The panes with pane receiving members applied can thus be shipped over great distances to the site of installation. The transport costs incurred include transport from the pane manufacturer or supplier to the factory in which the pane receiving members are applied and then to the site of installation. The present invention can reduce transport and storage costs which occur through the current double handling described above.

The above advantage also applies where panes are damaged either during or after installation. Instead of shipping a new pane from the factory in which the pane receiving members are applied to the panes as happens currently, a new pane can be shipped directly from a manufacturer or supplier to the site of installation. This can save time and cost and reduce inconvenience to the customer. The advantages discussed above can also have a further and significant impact on reducing the carbon footprint of manufacturing a window assembly, by reducing the amount of transport and storage undertaken in relation to glass panes.

The various alternative arrangements illustrated in FIGS. 4 to 7 illustrate that the invention can take a variety of different forms. However, each form includes a guide member that extends to a position between a pair of respective panes, or a pair of respective double glazed panes, or a mixture of single and double glazed panes, and that guide member includes a pair of seals which project in opposite directions for contacting facing surfaces of the respective panes. As will be readily appreciated, contact with the panes can be via direct contact with the pane surfaces, such as illustrated in FIG. 7, or with pane receiving members, as illustrated in FIGS. 3 to 6.

The invention described herein is susceptible to variations, modifications and/or additions other than those specifically described and it is to be understood that the invention includes all such variations, modifications and/or additions which fall within the spirit and scope of the present disclosure.

1. A sashless window comprising:
upper, lower and side frame members defining a generally square or rectangular frame,
first and second panes positioned within the frame substantially parallel to each other and at least the first pane being mounted for substantially vertical and parallel movement within the frame relative to the second pane,
each of the side frame members defining a channel into which opposite side edges of each of the first and second panes extend,
the channel including elongate guide members for guiding vertical movement of at least the first pane,
the channels of each of the side frame members including:
a first guide member extending to a position facing a front face of the first pane and a seal extending from the first guide member and into contact with the front face of the first pane,
a second guide member extending to a position facing a rear face of the second pane and a seal extending from the second guide member and into contact with the rear face of the second pane,
a third guide member extending to a position between the first and second panes and including a pair of seals projecting in opposite directions and extending into contact with facing surfaces of the first and second panes.

2. The sashless window according to claim 1, wherein the position at which the seals of the third guide member project from the third guide member is the same.

3. The sashless window according to claim 1, wherein the position at which the seals of the third guide member project from the third guide member is different.

4. The sashless window according to claim 3, wherein the third guide member has a lengthwise extent and the seals of the third guide member are spaced apart in the lengthwise direction of the third guide member.

5. The sashless window according to claim 1, wherein each of the seals of the third guide member has a base portion and each of the base portions is located in a groove formed in the third guide member.

6. The sashless window according to claim 5, wherein at least one of the seals of the third guide member includes a fin extending from the base portion out of the groove for contact with the facing surface of the respective one of the first and second panes.

7. The sashless window according to claim 5, wherein at least one of the seals of the third guide member includes a pile arrangement extending from the base portion out of the groove for contact with the facing surface of the respective one of the first and second panes.

8. The sashless window according to claim 6, wherein at least one of the seals of the third guide member includes a pile arrangement extending from the base portion out of the groove for contact with the facing surface of the respective one of the first and second panes.

9. The sashless window according to claim 1, wherein the first and second panes include pane receiving members fixed to the opposite side edges of each of the first and second panes and the pane receiving members are disposed at least substantially within the channels of the side frame members, so that the facing surfaces of the first and second panes that are engaged by the seals of the third guide member are facing surfaces of the pane receiving members.

10. The sashless window according to claim 9, wherein the pair of seals of the third guide member engages the facing surface of a respective first or second pane receiving member within a recess formed in that surface.

11. The sashless window according to claim 1, wherein the pair of seals of the third guide member are connected to a clip which is releasably attached to a distal end of the third guide member.

12. The sashless window according to claim 1, wherein the side frame members are formed of two parts that are connectable together and the third guide member is formed as one of the two parts.

13. The sashless window according to claim 1, wherein each of the first and second panes is mounted for substantially vertical and parallel movement within the frame relative to each other.

14. The sashless window according to claim 13, further including a third pane fixed within the frame substantially parallel to the first and second panes and the first and second panes being mounted for movement relative to the third pane.

15. The sashless window according to claim 1, wherein the second pane is fixed within the frame and the first pane is mounted for substantially vertical and parallel movement within the frame relative to the second frame.

16. The sashless window according to claim 15, further including a third pane fixed within the frame substantially parallel to the first and second panes and the first pane being mounted for substantially vertical and parallel movement within the frame relative to the second and third panes.

17. The sashless window according to claim 14, wherein the channels of each of the side frame members include:
a fourth guide member extending to a position facing a rear face of the third pane and a seal extending from the fourth guide member and into contact with the rear face of the third pane,
the second guide member extending to a position between the second and third panes and including a seal extending into contact with a facing surface of the third pane.

18. The sashless window according to claim 16, wherein the channels of each of the side frame members include:
a fourth guide member extending to a position facing a rear face of the third pane and a seal extending from the fourth guide member and into contact with the rear face of the third pane,
the second guide member extending to a position between the second and third panes and including a seal extending into contact with a facing surface of the third pane.

19. A sashless window comprising:
upper, lower and side frame members defining a generally square or rectangular frame,
first and second panes positioned within the frame substantially parallel to each other and at least the first pane being mounted for substantially vertical and parallel movement within the frame relative to the second pane,
each of the side frame members defining a channel into which opposite side edges of each of the first and second panes extend,
pane receiving members being fixed to the opposite side edges of each of the first and second panes and being disposed at least substantially within the channels of the side frame members,
the channel including elongate guide members for guiding vertical movement of at least the first pane,
the channels of each of the side frame members including:
a first guide member extending to a position facing a front face of a first of the pane receiving members attached to the side edge of the first pane and a seal extending from the first guide member and into contact with the front face of the first pane receiving member, a second guide member extending to a position facing a rear face of a second of the pane receiving members attached to the side edge of the second pane and a seal extending from the second guide member and into contact with the rear face of the second pane receiving member,
a third guide member extending to a position between the first and second pane receiving members and including a pair of seals projecting in opposite directions and extending into contact with facing surfaces of the first and second pane receiving members.
